(19) United States
(12) Patent Application Publication
(10) Pub. No.: US 2018/0060489 A1
(43) Pub. Date: Mar. 1, 2018

(54) METHOD AND SYSTEM FOR OUTPUTTING AN ITEM OF MEDICAL INFORMATION

(71) Applicant: Siemens Healthcare GmbH, Erlangen (DE)

(72) Inventors: Thomas ALLMENDINGER, Forchheim (DE); Daniel LERCH, Weilersbach (DE); Carsten THIERFELDER, Pinzberg (DE)

(73) Assignee: Siemens Healthcare GmbH, Erlangen (DE)

(21) Appl. No.: 15/673,488

(22) Filed: Aug. 10, 2017

(30) Foreign Application Priority Data
Aug. 24, 2016 (DE) 102016215922.4

(51) Int. Cl. G06F 19/00

(52) U.S. Cl. CPC G06F 19/321; G06F 19/3418

(57) ABSTRACT

A method and system are for outputting an item of medical information, the medical information concerning a suitability of a patient for an examination via a medical imaging device and/or the medical information concerning a patient-specific configuration of a medical imaging device, in particular for an examination of a patient. In an embodiment, the method includes acquisition of a measurement data series which relates to at least one physiological parameter of the patient via a first wearable which is worn by the patient; determination of the item of medical information on the basis of the measurement data series; and output of the item of medical information.

### PRIORITY STATEMENT

The present application hereby claims priority under 35 U.S.C. § 119 to German patent application number DE 102016215922.4 filed Aug. 24, 2016, the entire contents of which are hereby incorporated herein by reference.

### FIELD

At least one embodiment of the invention relates to a method for outputting an item of medical information. The invention also relates to a system comprising a first wearable. The invention further relates to a use of a first wearable for outputting an item of medical information. The invention further relates to a use of a system comprising a first wearable and a second wearable for outputting an item of medical information.

### BACKGROUND

The execution of an examination of the heart via a medical imaging device is, in many cases, always relatively complex and is substantially influenced, in its process, by the available hardware of the medical imaging device. The optimum settings to be used at the medical imaging device typically depend strongly on the individual patient characteristics, in particular the heart rate and the heart rhythm. A particular manifestation of this problem occurs when, by reason of the physiological parameters of the patient, for example, due to a very high heart rate, an arrhythmic heart rate or the like, the diagnostic image quality of the examination with the available medical imaging device is severely restricted. In such a case, provided there are no contraindications, it can be attempted to reduce the heart rate and, in particular, to induce a sinus rhythm. For this purpose, for example, beta blockers, sodium channel blockers or similar are used. In the conventional procedure, the overwhelming part of the testing of the heart rate takes place while the patient is situated on a patient positioning device of the medical imaging device and is connected, for example, to an ECG measuring system.

Several approaches for supporting the user of the medical imaging device during the selection and adaptation of examination parameters that are optimized in relation to a heart activity of the patient are known to a person skilled in the art, for example, from U.S. Pat. No. 8, 218,719 B2 and U.S. Pat. No. 8,611,987 B2, the entire contents of each of which are hereby incorporated herein by reference.

Since the medical imaging device is typically not used for the generation of medical images during the testing of the heart rate of the patient positioned on the patient positioning device, a heart imaging process is often associated with a relatively slow workflow and is regarded as restricting the throughput of the device. Alternatively, the suitability of the patient for an examination of the heart can take place with the aid of an ECG measuring system wherein the patient is not on the patient positioning device of the medical imaging device. In such a case, the interpretation and evaluation of the results output by the ECG measuring system is typically to be carried out with respect to the planned examination by a suitably qualified operating person. Although, in this way, the occupation of the medical imaging device can be prevented, additional time expenditure for a medical specialist is, however, associated therewith.

### SUMMARY

At least one embodiment of the invention provides an alternative to the conventional testing of a suitability of a patient for an examination via a medical imaging device.

Further embodiments of the invention are disclosed in the claims.

At least one embodiment of the invention relates to a method for outputting an item of medical information, the medical information concerning a suitability of a patient for an examination via a medical imaging device and/or the medical information concerning a patient-specific configuration of a medical imaging device, in particular for an examination of a patient, the method comprising:

acquisition of a measurement data series which relates to at least one physiological parameter of the patient via a first wearable which is worn by the patient,

determination of the item of medical information on the basis of the measurement data series, and

output of the item of medical information.

At least one embodiment of the invention relates to a system, comprising

a first wearable with an acquisition unit which is configured for the acquisition of a measurement data series which relates to at least one physiological parameter of the patient,

a determination unit which is configured for determining an item of medical information on the basis of the measurement data series, the medical information concerning a suitability of a patient for an examination via a medical imaging device and/or the medical information concerning a patient-specific configuration of a medical imaging device, in particular for an examination of a patient, and

an output unit which is configured for outputting the item of medical information.

At least one embodiment of the invention relates to a system according to one of the embodiments which are disclosed in this description and/or in the claims, which is configured for carrying out a method according to one of the embodiments disclosed in this description and/or in the claims.

At least one embodiment of the invention further relates to a use of a first wearable for outputting an item of medical information, the item of medical information concerning a suitability of a patient for an examination via a medical imaging device and/or the item of medical information concerning a patient-specific configuration of a medical imaging device, in particular for an examination of a patient, comprising

a measurement data series which relates to at least one physiological parameter of the patient being acquired via the first wearable which is worn by the patient,

the item of medical information being determined on the basis of the measurement data series,

wherein the item of medical information is output.

At least one embodiment of the invention further relates to a use of a system having a first wearable and a second wearable for outputting an item of medical information, the item of medical information concerning a suitability of a patient for an examination via a medical imaging device and/or the item of medical information concerning a patient-specific configuration of a medical imaging device, in particular for an examination of a patient, comprising

a measurement data series which relates to at least one physiological parameter of the patient being acquired via the first wearable which is worn by the patient,

the item of medical information being determined on the basis of the measurement data series,

wherein the item of medical information is output via the second wearable.

In at least one embodiment of the inventive solution, the medical imaging device is not unnecessarily blocked by preparation measures, so that an increased patient throughput is realizable with the medical imaging device. In particular, at least one embodiment of the inventive solution enables a continuous observation of the physiological parameters of the patient over an extended time period without blocking the medical imaging device. Thus, particular pathologies which relate, for example, to heart activity and/or occur only sporadically or in (psychological) stress situations can be better recognized. By contrast, in a conventional test of a suitability of a patient for an examination via a medical imaging device, the ECG measurement is restricted to a relatively short time interval in order not to delay the examination unnecessarily.

A wearable can be understood, in particular, to be a computer system integrated into the clothing of a user and/or wearable on the body of a user. The wearable can be configured, in particular, to acquire and/or process data which relates to the user and/or his environment. In particular, the wearable can be integrated into the clothing of the user and/or wearable on the body of the user such that the user has both hands free and/or such that the visual field of the user is not restricted by the wearable. A user can be understood to be, for example, a patient and/or an operating person, in particular a doctor or medical technician. The wearable can be and/or comprise a smartwatch. The wearable can, for example, be and/or comprise a fitness tracker. Smartwatches with which a measurement data series which relates to at least one physiological parameter of the patient can be acquired are known to persons skilled in the art. Examples of such smartwatches are Apple Watch, Sony Smartwatch 3 and Samsung Galaxy Gear.

According to one embodiment of the invention, the medical imaging device comprises an acquisition unit which is configured for the acquisition of the acquisition data. In particular, the acquisition unit can comprise a radiation source and a radiation detector. One embodiment of the invention provides that the radiation source is configured for emission and/or for excitation of a radiation, in particular an electromagnetic radiation and/or that the radiation detector is configured for the detection of the radiation, in particular the electromagnetic radiation. The radiation can pass, for example, from the radiation source to a region to be imaged and/or following an interaction with the region to be imaged, to the radiation detector. In the interaction with the region to be imaged, the radiation is modified and thus becomes a carrier of information which relates to the region to be imaged. In the interaction of the radiation with the detector, this information is acquired in the form of acquisition data.

According to one embodiment of the invention, a method comprises:

acquiring, via a first wearable, a measurement data series relating to at least one physiological parameter of a patient wearing the first wearable; and

outputting, via the first wearable, an item of medical information determined based upon the measurement data series, the item of medical information being one which concerns at least one of a suitability of a patient for an examination via a medical imaging device and a patient-specific configuration of a medical imaging device for an examination of a patient.

According to one embodiment of the invention, a method comprises:

acquiring, via a system including a first wearable and a second wearable, a measurement data series relating to at least one physiological parameter of a patient wearing the first wearable; and

outputting, via the second wearable, an item of medical information determined based upon the measurement data series, the item of medical information being one which concerns at least one of a suitability of a patient for an examination via a medical imaging device and a patient-specific configuration of a medical imaging device for an examination of a patient.

### BRIEF DESCRIPTION OF THE DRAWINGS

Selected example embodiments will now be described making reference to the accompanying drawings. The illustrations in the figures are schematic, greatly simplified and not necessarily to scale.

In the drawings:

FIG. 1 is a flow diagram for a method for outputting an item of medical information according to one embodiment of the invention,

FIG. 2 is a flow diagram for a method for outputting an item of medical information according to a further embodiment of the invention,

FIG. 3 is a system according to one embodiment of the invention,

FIG. 4 is a system according to a further embodiment of the invention,

FIG. 5 is a system with a first wearable according to a further embodiment of the invention,

FIG. 6 is a system with a first wearable and a second wearable according to a further embodiment of the invention,

FIG. 7 is a system with a plurality of first wearables and a second wearable according to a further embodiment of the invention, and

FIG. 8 is a system with a medical imaging device according to a further embodiment of the invention.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or porcessors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (procesor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

At least one embodiment of the invention relates to a method for outputting an item of medical information, the medical information concerning a suitability of a patient for an examination via a medical imaging device and/or the medical information concerning a patient-specific configuration of a medical imaging device, in particular for an examination of a patient, the method comprising:

acquisition of a measurement data series which relates to at least one physiological parameter of the patient via a first wearable which is worn by the patient,

determination of the item of medical information on the basis of the measurement data series, and

output of the item of medical information.

In particular, the wearable can comprise a first data processing unit. In particular, a first software application can be executed by the first data processing unit. In particular, the item of medical information can be determined and/or output by way of the first software application.

In particular, an item of reference information can be provided. The reference information can concern, for example, an identification of the examination and/or the medical imaging device. The reference information can concern, for example, an examination-specific condition and/or device-specific condition on the at least one physiological parameter of the patient. The medical information can be determined, for example, on the basis of the measurement data series and on the basis of the reference information.

In particular, data can be transferred between the first wearable and a data processing system the data comprising at least one element which is selected from the group which consists of the measurement data series, the medical information, the reference information and combinations thereof.

The data processing system can have, for example, a second data processing unit. The second software application can be executed, for example, by the second data processing unit. The medical information can be determined and/or output, for example, by way of the second software application.

In particular, the data processing system can be and/or comprise a second wearable which is worn by the operating person. In particular, the second wearable can comprise the second data processing unit.

In particular, the first wearable can comprise a first display unit. In particular, the data processing system can comprise a second display unit. The medical information can be displayed, for example, via the first display unit and/or via the second display unit.

In particular, data can be transferred between the first wearable and the medical imaging device. In particular, data can be transferred between the data processing system, in particular the second wearable, and the medical imaging device. In particular, the data can comprise at least one element which is selected from the group which consists of the measurement data series, the medical information, the reference information and combinations thereof.

In particular, an examination parameter of the medical imaging device can be adapted on the basis of the medical information.

In particular, the medical information can comprise a first item of information which indicates whether the patient is suitable for the examination via the medical imaging device. In particular, the medical information can comprise a second item of information which indicates whether and/or how the suitability of the patient for the examination can be created and/or improved. In particular, the medical information can comprise a third item of information which relates to a characteristic variable of the physiological parameter of the patient and/or a measure for a deviation of the characteristic variable of the physiological parameter of the patient from a reference value. In particular, the medical information can comprise a fourth item of information which indicates whether and/or how the configuration of the medical imaging device can be patient-specifically optimized for the examination of the patient.

In particular, the measurement data series can relate to a heart activity of the patient.

At least one embodiment of the invention relates to a system, comprising

a first wearable with an acquisition unit which is configured for the acquisition of a measurement data series which relates to at least one physiological parameter of the patient,

a determination unit which is configured for determining an item of medical information on the basis of the measurement data series, the medical information concerning a suitability of a patient for an examination via a medical imaging device and/or the medical information concerning a patient-specific configuration of a medical imaging device, in particular for an examination of a patient, and

an output unit which is configured for outputting the item of medical information.

In particular, the system can further comprise at least the following components:

a data processing system,

a data transfer unit which is configured for transferring data between the first wearable and the data processing system, and

the data processing system comprising the determination unit and/or the output unit.

In particular, the first wearable can comprise the determination unit and/or the output unit. In particular, the data processing system can comprise a second wearable which comprises the determination unit and/or the output unit.

According to one embodiment of the invention, a method comprises:

acquiring, via a system including a first wearable and a second wearable, a measurement data series relating to at least one physiological parameter of a patient wearing the first wearable; and

outputting, via the second wearable, an item of medical information determined based upon the measurement data series, the item of medical information being one which concerns at least one of a suitability of a patient for an examination via a medical imaging device and a patient-specific configuration of a medical imaging device for an examination of a patient.

In particular, the system can further comprise the at least the following components:

the medical imaging device,

a data transfer unit, and

an examination parameter adaptation unit which is configured for the adaptation of at least one examination parameter of the medical imaging device on the basis of the medical information.

In particular, the data transfer unit can be configured for the transfer of data between the first wearable and the medical imaging device. In particular, the data transfer unit can be configured for the transfer of data between the data processing system, in particular the second wearable, and the medical imaging device.

At least one embodiment of the invention relates to a system according to one of the embodiments which are disclosed in this description and/or in the claims, which is configured for carrying out a method according to one of the embodiments disclosed in this description and/or in the claims.

At least one embodiment of the invention further relates to a use of a first wearable for outputting an item of medical information, the item of medical information concerning a suitability of a patient for an examination via a medical imaging device and/or the item of medical information concerning a patient-specific configuration of a medical imaging device, in particular for an examination of a patient, comprising

a measurement data series which relates to at least one physiological parameter of the patient being acquired via the first wearable which is worn by the patient, and

the item of medical information being determined on the basis of the measurement data series,

wherein the item of medical information is output.

According to one embodiment of the invention, a method comprises:

acquiring, via a first wearable, a measurement data series relating to at least one physiological parameter of a patient wearing the first wearable; and

outputting, via the first wearable, an item of medical information determined based upon the measurement data series, the item of medical information being one which concerns at least one of a suitability of a patient for an examination via a medical imaging device and a patient-specific configuration of a medical imaging device for an examination of a patient.

At least one embodiment of the invention further relates to a use of a system having a first wearable and a second wearable for outputting an item of medical information, the item of medical information concerning a suitability of a patient for an examination via a medical imaging device and/or the item of medical information concerning a patient-specific configuration of a medical imaging device, in particular for an examination of a patient, comprising

a measurement data series which relates to at least one physiological parameter of the patient being acquired via the first wearable which is worn by the patient,

the item of medical information being determined on the basis of the measurement data series,

wherein the item of medical information is output via the second wearable.

According to one embodiment of the invention, a method comprises:

acquiring, via a system including a first wearable and a second wearable, a measurement data series relating to at least one physiological parameter of a patient wearing the first wearable; and

outputting, via the second wearable, an item of medical information determined based upon the measurement data series, the item of medical information being one which concerns at least one of a suitability of a patient for an examination via a medical imaging device and a patient-specific configuration of a medical imaging device for an examination of a patient.

In particular, the item of medical information can be determined via the first wearable and/or via the second wearable on the basis of the measurement data series. In particular, the item of medical information can be output via the first wearable and/or via the second wearable.

The inventors have discovered that it is advantageous to enable a continuous observation of the patient with regard to his suitability for an examination via a medical imaging device over a relatively long time period, and that it is not useful in particular to occupy a medical imaging device with a patient if it can be ascertained during the testing of the suitability of the patient that the patient is not suitable for the examination via the medical imaging device and/or measures are to be carried out in order to create and/or improve the suitability of the patient for the examination.

At least one embodiment of the invention enables the displacement of the testing of the suitability of the patient away from the medical imaging device to a mobile solution which, in particular, is economical and is realizable independently of the medical imaging device. Thus a continuous observation of the patient with regard to his suitability for an examination via a medical imaging device over an extended time period is realizable without the medical imaging device meanwhile being occupied by the patient whose suitability is being tested. According to one aspect of the invention, the measurement data series is acquired while the patient is in a position remote from the medical imaging device and/or while the medical imaging device, in particular the patient positioning device of the medical imaging device, is not occupied by the patient.

In at least one embodiment of the inventive solution, the medical imaging device is not unnecessarily blocked by preparation measures, so that an increased patient throughput is realizable with the medical imaging device. In particular, at least one embodiment of the inventive solution enables a continuous observation of the physiological parameters of the patient over an extended time period without blocking the medical imaging device. Thus, particular pathologies which relate, for example, to heart activity and/or occur only sporadically or in (psychological) stress situations can be better recognized. By contrast, in a conventional test of a suitability of a patient for an examination via a medical imaging device, the ECG measurement is restricted to a relatively short time interval in order not to delay the examination unnecessarily.

A wearable can be understood, in particular, to be a computer system integrated into the clothing of a user and/or wearable on the body of a user. The wearable can be configured, in particular, to acquire and/or process data which relates to the user and/or his environment. In particular, the wearable can be integrated into the clothing of the user and/or wearable on the body of the user such that the user has both hands free and/or such that the visual field of the user is not restricted by the wearable. A user can be understood to be, for example, a patient and/or an operating person, in particular a doctor or medical technician. The wearable can be and/or comprise a smartwatch. The wearable can, for example, be and/or comprise a fitness tracker. Smartwatches with which a measurement data series which relates to at least one physiological parameter of the patient can be acquired are known to persons skilled in the art. Examples of such smartwatches are Apple Watch, Sony Smartwatch 3 and Samsung Galaxy Gear.

The wearable can be integrated, for example, into a clothing item, in particular a shirt and/or can have a component which is integrated into a clothing item. The wearable can comprise, for example, an armband wherein the wearable can be worn on an arm of the user via the armband. Herein, the wearable can be worn, for example, in the form of a wristwatch on a wrist of the user or in the form of a fitness armband on an arm of the user.

The wearable can comprise, for example, an assembly which forms a region of the armband and/or which is arranged on the armband. The assembly can comprise, for example, the data processing unit, a display unit, a data transfer module for, in particular, cable-free data transfer and an energy supply unit for supplying the components of the wearable with electrical energy. The wearable can, for example, comprise a data processing unit. On the data processing unit, for example, a software application can be installed. The software application can be executed by the data processing unit.

The first data processing unit is configured according to one of the embodiments of a data processing unit which are disclosed in this description and/or in the claims. The second data processing unit is configured according to one of the embodiments of a data processing unit which are disclosed in this description and/or in the claims. The first data processing unit and the second data processing unit can be configured differently.

In particular, an interface for the transfer of information between the first software application and the second software application can be provided. In particular, such an interface can be based on the client-server model. In a storage region of the interface, for example, a file with the information to be transferred can be stored by the first software application and/or the second software application and read by the first software application and/or the second software application. The format of the file can, for example, be selected to be universal such that in this way, information can also be transferred between a first software application and a second software application which has been provided by different manufacturers. In particular, the first wearable and/or the second wearable can be configurable by way of the first software application and/or the second software application.

The first wearable is configured according to one of the embodiments of a wearable which are disclosed in this description and/or in the claims. The second wearable is configured according to one of the embodiments of a wearable which are disclosed in this description and/or in the claims. The first wearable and the second wearable can be configured differently. The second wearable can be worn, for example, by a user. The measurement data series can be understood, for example, as an input of the first software application and/or an input of the second software application, the medical information being determined on the basis of the input.

The wearable can have, for example, a sensor unit which is configured for measuring the at least one physiological parameter of the patient. In particular, the sensor unit can form a contact with a region of the surface of the patient. The sensor unit can be configured, in particular, to detect in the region of the surface of the patient an electrical signal, an optical signal, an acoustic signal, a color, a movement, a temperature, a temperature change or similar or combinations thereof. The sensor unit can be, for example, a clothing item, in particular a shirt and/or can have a component which is integrated into a clothing item.

According to one embodiment of the invention, a method comprises:

acquiring, via a first wearable, a measurement data series relating to at least one physiological parameter of a patient wearing the first wearable; and

outputting, via the first wearable, an item of medical information determined based upon the measurement data series, the item of medical information being one which concerns at least one of a suitability of a patient for an examination via a medical imaging device and a patient-specific configuration of a medical imaging device for an examination of a patient.

The examination via the medical imaging device can be, for example, a heart imaging and/or can comprise a heart imaging. The measurement data series can be acquired, for example, in that the heart activity is measured via a sensor unit which is configured to measure the heart activity of the patient. A measurement data series which relates to at least one physiological parameter can be, in particular, a measurement data series which relates to a heart activity of the patient. The at least one physiological parameter can be, in particular, one or more vital parameters. The at least one physiological parameter can be, in particular, one or more parameters which relate to the heart activity of the patient.

Examples of a physiological parameter, in particular in relation to a heart activity are a heartbeat frequency, a regularity of the heartbeat, a rhythm of the heartbeat, a pulse strength, a pulse amplitude, a pulse rate rise steepness, a blood pressure, a blood pressure rise speed, a filling volume or similar or combinations thereof. Further examples of a physiological parameter are a skin conductivity, a brain activity, a muscle activity, a peripheral perfusion, a respiratory frequency, a body temperature, an oxygen saturation, a blood sugar value, a movement intensity, a physical hyperactivity (unrest) or similar or combinations thereof. In particular, via a measuring system, a measurement data set can be acquired which relates to at least one further physiological parameter of the patient which is not acquired by way of the first wearable. The medical information can be determined, for example, on the basis of the measurement data series and on the basis of the measurement data set.

The medical information can be output, for example, in that the medical information is displayed via a display unit and/or in that the medical information is placed in a storage unit and/or in that the medical information is transferred via data transmission which can, in particular, be wireless.

The software application can be configured, for example, such that on the basis of the measurement data series and/or the reference information and/or further physiological parameters and/or a patient parameter set, to determine a first item of information which indicates whether the patient is suitable for the examination via the medical imaging device or not. The patient parameter set can, for example, have parameters which relate to the sex of the patient, the weight of the patient, the height of the patient and/or the age of the patient. The patient parameter set can be prepared, for example, with the aid of an electronic health file (EMR=electronic medical record”, EHR—electronic health record).

The first item of information can be, for example, an item of binary information, in particular a Yes-No response. For example, the first information item can indicate whether the patient is suitable for a Ca scoring test. In such a case, the reference information can relate, for example, to conditions on the at least one physiological parameter of the patient which are specific for a Ca scoring test. For example, the first information item can indicate whether the patient is suitable for a cranial computed tomography (CCT). In such a case, the reference information can relate, for example, to the at least one physiological parameter of the patient which are specific for a cranial computed tomography. The reference information can be generated, for example, by way of the first software application and/or by way of the second software application and/or via a control device of the medical imaging device.

The software application can be configured, for example, on the basis of the measurement data series and/or the reference information and/or further physiological parameters and/or a patient parameter set, to determine a second item of information which indicates whether and/or how the suitability of the patient for the examination can be created and/or improved. The second item of information can indicate, for example, whether and/or to what extent and/or how a reduction of the heart rate is realizable with the aid of beta blockers and/or the creation of a regular rhythm with the aid of antiarrhythmic agents, in particular in order to create a suitability of the patient for the examination.

According to one embodiment of the invention, a method comprises:

acquiring, via a system including a first wearable and a second wearable, a measurement data series relating to at least one physiological parameter of a patient wearing the first wearable; and

outputting, via the second wearable, an item of medical information determined based upon the measurement data series, the item of medical information being one which concerns at least one of a suitability of a patient for an examination via a medical imaging device and a patient-specific configuration of a medical imaging device for an examination of a patient.

The software application can be configured, for example, on the basis of the measurement data series and/or the reference information and/or further physiological parameters and/or a patient parameter set, to determine a third item of information which relates to a characteristic variable of the physiological parameter of the patient and/or a measure for a deviation of a characteristic variable of the physiological parameter of the patient from a reference value. In particular, the characteristic variable of the physiological parameter can be determined by way of the software application on the basis of the measurement data series. In particular, the medical information can comprise the characteristic variable. An example for such a characteristic variable is the heartbeat frequency in beats per minute, which can be averaged, in particular, over a time interval. In particular, a warning signal can be output if the deviation exceeds or undershoots a threshold value. In this way, a monitoring of the patient is realizable. In particular, on the basis of the administration of, for example, beta blockers, side effects can arise which require an intervention by the medical personnel. The warning signal can be output, for example, via the data processing system, in particular, via the second wearable, visually and/or acoustically.

The software application can be configured, for example, on the basis of the measurement data series and/or the reference information and/or further physiological parameters and/or a patient parameter set, to determine a fourth item of information which indicates whether and/or how the configuration of the medical imaging device can be patient-specifically optimized for the examination of the patient. In particular, on the basis of the fourth item of information, the medical imaging device can be patient-specifically configured, in particular, in relation to the at least one examination parameter.

In particular, the first software application can be embedded into a first graphical user interface which is installed, for example, on the first data processing unit and/or which is output, for example, via the first display unit. In particular, the second software application can be embedded into a second graphical user interface which is installed, for example, on the second data processing unit and/or which is output, for example, via the second display unit.

The first software application is configured according to one of the embodiments of a software application, which are disclosed in this description and/or in the claims. The second software application is configured according to one of the embodiments of a software application, which are disclosed in this description and/or in the claims. The first software application and the second software application can be configured differently. The examination-specific condition can be, for example, specific for the examination of the patient via the medical imaging device. The device-specific condition can be, for example, specific for the medical imaging device. The patient-specific configuration of the medical imaging device can be, for example, specific for the patient.

A data processing unit can have, for example, one or more components in the form of hardware and/or one or more components in the form of software. The data processing system can have, for example, one or more components in the form of hardware and/or one or more components in the form of software. The data processing system can be configured, for example, partially by a cloud computing system. The data processing system can be and/or comprise, for example, a cloud computing system, a computer network, a computer, a tablet computer, a smartphone or the like or combinations thereof. The hardware can cooperate, for example, with a software and/or can be configurable by way of a software. The software can be configured, for example, by way of the hardware. The hardware can be, for example, a storage system, an FPGA system (field-programmable gate array) and ASIC system (application-specific integrated circuit), a microcontroller system, a processor system and combinations thereof. The processor system can comprise, for example, a microprocessor and/or a plurality of cooperating microprocessors.

In particular, one component of a system according to one of the embodiments which are disclosed in this description and/or in the claims, which is configured for carrying out a defined step of a method according to one of the embodiments disclosed in this description and/or in the claims can be implemented in the form of a hardware which is configured to carry out the defined step and/or which is configured to carry out the defined step and/or which is configured to carry out a computer-readable instruction such that the hardware is configurable by way of the computer-readable instruction for carrying out the defined step. In particular, the system can have a storage region, for example in the form of a computer-readable medium in which computer-readable instructions, for example, in the form of a computer program, are stored.

A data transfer between components of the data processing unit can take place, for example, via a suitable data transfer interface. The data transfer interface for data transfer to and/or from a component of the data processing unit can be realizable at least partially in the form of software and/or at least partially in the form of hardware. The data transfer interface can be configured, for example, for storing data in and/or for loading data from a region of the storage system, wherein one or more components of the data processing unit can access this region of the storage system.

The medical imaging device can be selected, for example, from the imaging modality group which consists of an X-ray device, a C-arm X-ray device, a computed tomography (CT) device, a molecular imaging (MI) device, a single-photon emission computed tomography (SPECT) device, a positron emission tomography (PET) device, a magnetic resonance tomography (MRT) device and combinations thereof (in particular PET-CT device, PET-MR device). The medical imaging device can further have a combination of an imaging modality which is selected, for example, from the imaging modalities group and an irradiation modality. Herein, the irradiation modality can comprise, for example, an irradiation unit for therapeutic irradiation. Without restricting the general inventive concept, in some of the embodiments, a computed tomography device is cited as an example for a medical imaging device.

According to one embodiment of the invention, the medical imaging device comprises an acquisition unit which is configured for the acquisition of the acquisition data. In particular, the acquisition unit can comprise a radiation source and a radiation detector. One embodiment of the invention provides that the radiation source is configured for emission and/or for excitation of a radiation, in particular an electromagnetic radiation and/or that the radiation detector is configured for the detection of the radiation, in particular the electromagnetic radiation. The radiation can pass, for example, from the radiation source to a region to be imaged and/or following an interaction with the region to be imaged, to the radiation detector. In the interaction with the region to be imaged, the radiation is modified and thus becomes a carrier of information which relates to the region to be imaged. In the interaction of the radiation with the detector, this information is acquired in the form of acquisition data.

In particular, in a computed tomography device and in a C-arm X-ray device, the acquisition data can be projection data, the acquisition unit can be a projection data acquisition unit, the radiation source can be an X-ray source, the radiation detector can be an X-ray detector. The X-ray detector can be, in particular, a quantum-counting and/or energy-resolving X-ray detector.

In particular in a magnetic resonance tomography device, the acquisition data can be a magnetic resonance data set, the acquisition unit can be a magnetic resonance data acquisition unit, the radiation source can be a first high frequency antenna unit, the radiation detector can be the first high frequency antenna unit and/or a second high frequency antenna unit.

In the context of at least one embodiment of the invention, features which are described in relation to different embodiments of the invention and/or different claim categories (method, device, system, etc.) can be combined to further embodiments of the invention. In other words, the object claims can also be further developed with the features disclosed or claimed in conjunction with a method. Functional features of a method can herein be carried out by way of correspondingly configured object components. Apart from the embodiments of the invention expressly described in this application, many further embodiments of the invention are conceivable, at which the skilled person can arrive without departing from the scope of the invention, insofar as it is defined by the claims.

The use of the indefinite article “a” or “an” does not preclude that the relevant features can also be present plurally. The use of the expression “comprise” does not preclude that the expressions linked by way of the expression “comprise” can be identical. For example, the medical imaging device comprises the medical imaging device. The use of the expression “unit” does not preclude that the subject matter to which the expression “unit” relates can have a plurality of components that are spatially separated from one another.

The use of ordinal number words (first, second, third, etc.) in the description of features serves in the context of the present application primarily for the better distinguishability of the features described using the ordinal number words. The absence of a feature which is defined by a combination of a specific ordinal number word and an expression does not preclude that a feature can be present which is designated by a combination of an ordinal number word following the given ordinal number word and the expression.

The expression “on the basis of” can be understood in the context of the present application in particular in the sense of the expression “by using”. In particular, a formulation as a result of which a first feature is created (alternatively: determined, specified, etc.) on the basis of a second feature does not preclude that the first feature can be created (alternatively: determined, specified, etc.) on the basis of a third feature.

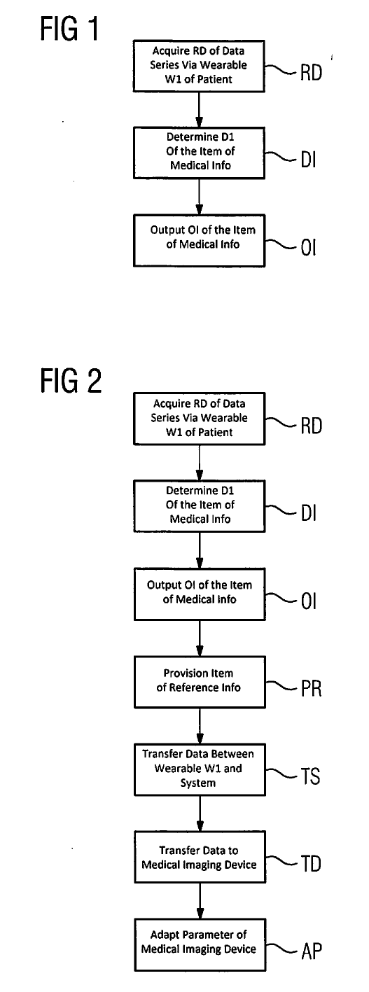

FIG. 1 shows a flow diagram for a method for outputting an item of medical information according to one embodiment of the invention, the method comprising:

acquisition RD of a measurement data series which relates to at least one physiological parameter of the patient 13 via a first wearable W1 which is worn by the patient 13,

determination DI of the item of medical information which concerns a suitability of a patient 13 for an examination via a medical imaging device 2 and/or a patient-specific configuration of a medical imaging device 2, in particular for an examination of a patient 13, on the basis of the measurement data series, and

output OI of the item of medical information.

FIG. 2 shows a flow diagram for a method for outputting an item of medical information according to a further embodiment of the invention, the method further comprising:

provision PR of an item of reference information which concerns an identification of the examination and/or the medical imaging device 2 and/or which concerns an examination-specific condition and/or device-specific condition on the at least one physiological parameter of the patient 13,

transfer TS of data between the first wearable W1 and a data processing system,

transfer TD of data between the first wearable W1 and the medical imaging device 2 and/or between the data processing system and the medical imaging device 2, and

adaptation AP of at least one examination parameter of the medical imaging device 2 on the basis of the item of medical information. Herein the item of medical information can be determined on the basis of the measurement data series and on the basis of the reference information. In particular, the data can comprise at least one element which is selected from the group which consists of the measurement data series, the medical information, the reference information and combinations thereof.

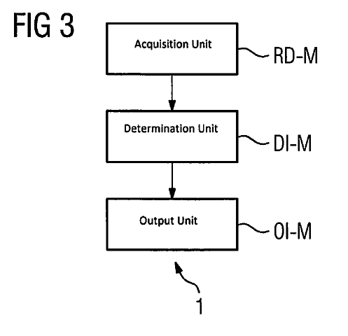

FIG. 3 shows a system 1 according to an embodiment of the invention, comprising

an acquisition unit RD-M,

a determination unit DI-M, and

an output unit OI-M.

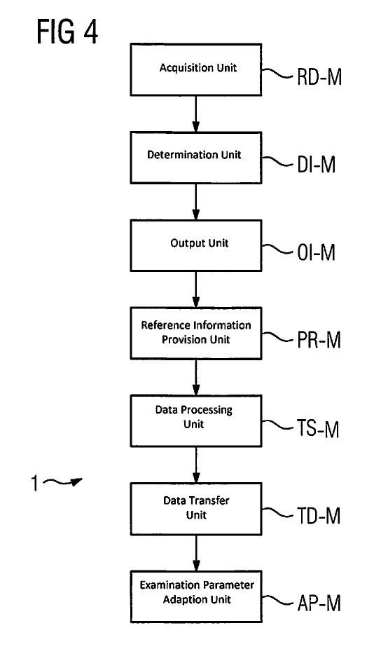

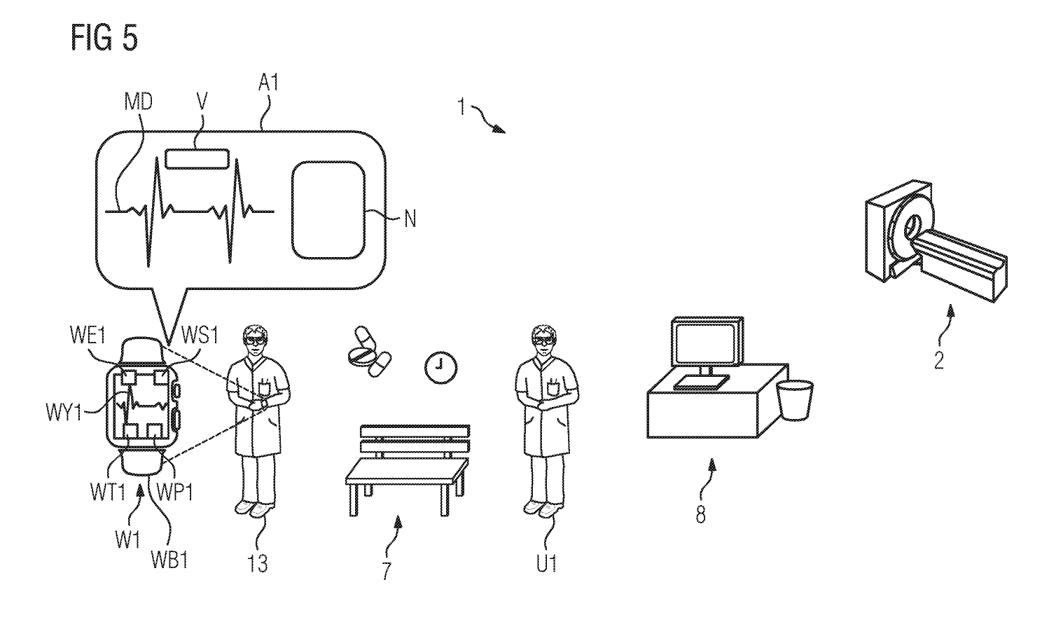

FIG. 4 shows a system 1 according to a further embodiment of the invention, further comprising

a reference information provision unit PR-M which is configured for providing PR the reference information,

a data processing unit TS-M which is configured for transferring TS data between the first wearable W1 and the data processing system,

a data transfer unit TD-M which is configured for the transfer TD of data between the first wearable W1 and the medical imaging device 2 and/or between the data processing system and the medical imaging device 2, and

an examination parameter adaptation unit AP-M which is configured for the adaptation AP of at least one examination parameter of the medical imaging device 2 on the basis of the item of medical information.

FIG. 5 shows a system 1 with a first wearable according to a further embodiment of the invention. The first software application A1 is executed by the first data processing unit WP1 of the first wearable W1. The item of medical information is determined and output by way of the first software application A1 on the basis of the measurement data series MD. The first wearable W1 is worn in the form of a smartwatch by the patient 13. The first wearable W1 has the following components: the first armband WB1, the first sensor unit WS1, the first data processing unit WP1, the first display unit WY1, the second data transfer module WT1, in particular for wireless data transfer and the first energy supply unit WE1, for example, in the form of a rechargeable electric battery, in order to supply the components of the first wearable W1 with electrical energy.

The item of medical information N can be output by way of the first software application A1 in that the item of medical information N is displayed by the first display unit WY1 of the first wearable W1. Optionally, the measurement data series MD can be output by the first software application A1 in that the measurement data series MD is displayed by the first display unit WY1 of the first wearable W1. Via the first display unit WY1, the measurement data series MD and/or the item of medical information N and/or a value V of a characteristic variable of a physiological parameter can be displayed. The value V can be, in particular, the heartbeat frequency of the patient 13, which can be, for example, 63 beats per minute.

The patient 13 is situated in a patient reception area 7, for example a waiting room. The operating person U1, for example, a doctor or a medical technician can take account of the medical information N by observing the first display unit. The operating person U1 can observe the first display unit WY1 of the first wearable W1 when he is in the vicinity of the patient 13. As a rule, for this purpose, it is necessary that the operating person removes himself from the working area 8. The working area 8 can be, for example, a console room in which a console for controlling the medical imaging device 2 is situated and/or an examination room in which the medical imaging device 2 is situated. In particular, if measures for producing and/or improving the suitability of the patient 13 have been introduced, for example beta blockers have been administered to the patient 13, the operating person can observe the course of the physiological parameters by observation of the first display unit at regular intervals and/or ascertain the suitability of the patient 13.

According to one embodiment of the invention, a method comprises:

acquiring, via a system including a first wearable and a second wearable, a measurement data series relating to at least one physiological parameter of a patient wearing the first wearable; and

outputting, via the second wearable, an item of medical information determined based upon the measurement data series, the item of medical information being one which concerns at least one of a suitability of a patient for an examination via a medical imaging device and a patient-specific configuration of a medical imaging device for an examination of a patient.

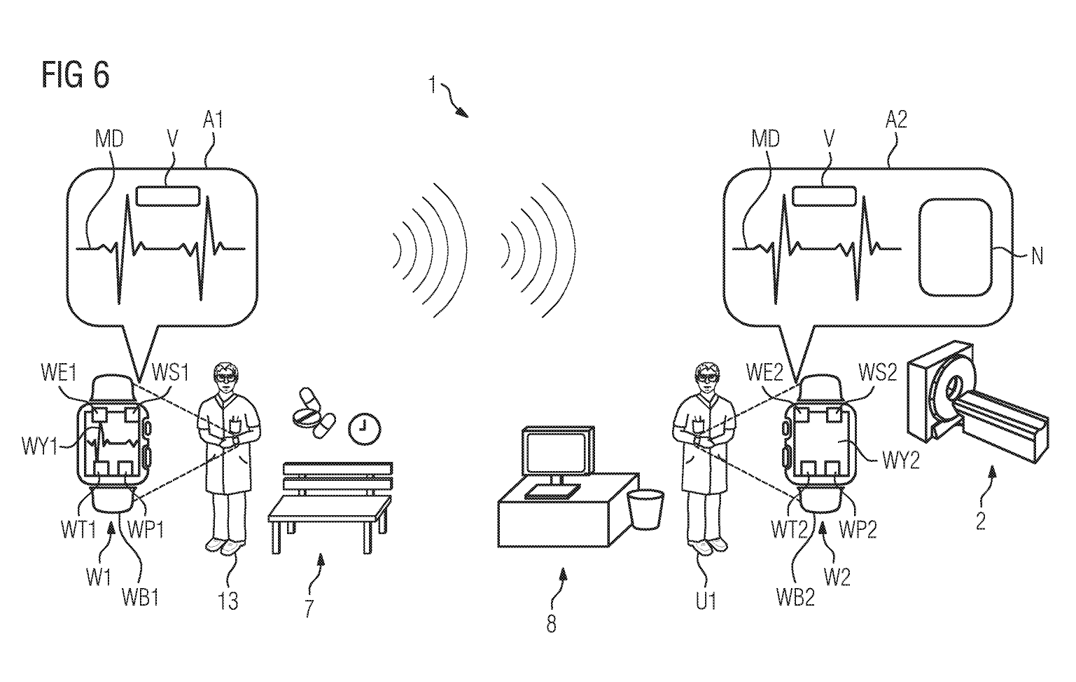

FIG. 6 shows a system 1 with a first wearable and a second wearable according to a further embodiment of the invention. In the embodiment of the invention shown in FIG. 6, the item of medical information N and the measurement data series MD are transferred from the first wearable W1 to the second wearable W2. The second wearable W2 is worn in the form of a smartwatch by the operating person U1. The second wearable W2 has the following components: the second armband WB2, the second sensor unit WS2, the second data processing unit WP2, the second display unit WY2, the second data transfer module WT2, in particular, for wireless data transfer and the second energy supply unit WE2, for example, in the form of a rechargeable electric battery for supplying the components of the second wearable W2 with electrical energy.

The second software application A2 is executed by the second data processing unit WP2 of the second wearable W2. The item of medical information N can be output by way of the second software application A2 in that the item of medical information N is displayed by the second display unit WY2 of the second wearable W2. Optionally, the measurement data series MD can be output by the second software application A2 in that the measurement data series MD is displayed by the second display unit WY2 of the second wearable W2. Via the second display unit WY2, the measurement data series MD and/or the item of medical information N and/or a value V of a characteristic variable of a physiological parameter can be displayed. In this way, the medical information N and/or the measurement data series MD can be observed by the operating person whilst he carries out further activities, for example, in the working area 8 and/or while he is not in the same room as the patient whose suitability is being tested.

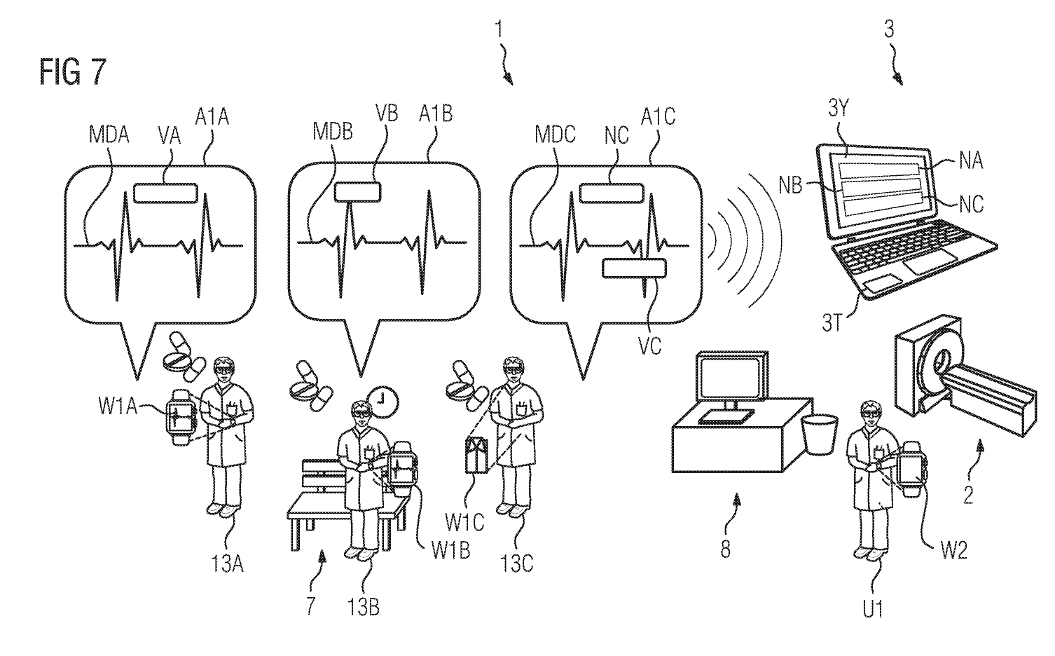

FIG. 7 shows a system 1 with a plurality of first wearables and a second wearable according to a further embodiment of the invention. In the embodiment of the invention shown in FIG. 7, for each patient of a plurality of patients, a measurement data series which relates to at least one physiological parameter of the respective patient is acquired via a first wearable which is worn by the respective patient. Each patient of the plurality of patients wears at least one first wearable which is configured according to one of the aspects of a wearable which are disclosed in this description and/or in the claims. In particular, the wearables W1A, W1B, W1C can differ from one another.

The patient 13A wears the first wearable W1A in the form of a smartwatch which comprises a data processing unit by which the first software application A1A is executed. The measurement data series MDA is acquired via the first wearable W1A. The value VA is the heartbeat frequency of the patient 13A, for example 63 beats per minute. The patient 13B wears the first wearable W1B in the form of a smartwatch which comprises a data processing unit by which the first software application A1B is executed. The measurement data series MDB is acquired via the first wearable W1B. The value VB is the heartbeat frequency of the patient 13B, for example 76 beats per minute. The patient 13C wears the first wearable W1C in the form of a data processing unit by which the first software application A1C is executed. The measurement data series MDC is acquired via the first wearable W1C. The value VC is the heartbeat frequency of the patient 13C, for example 92 beats per minute. The wearable W1C is integrated into a clothing item, for example, a shirt which the patient 13C wears.

The acquisition of the measurement data series MDA, MDB and MDC can take place, for example, in parallel. For each patient of the plurality of patients, an item of medical information on the basis of the respective measurement data series MDA, MDB, MDC is determined, the medical information concerning a suitability of the respective patient for an examination via the medical imaging device 2 and/or a patient-specific configuration of the medical imaging device 2 for an examination of the respective patient. For each patient of the plurality of patients, the item of medical information is transferred to the data processing system which comprises the computer 3 and the second wearable W2.

The computer 3 comprises, in particular, the screen 3Y and the data transfer module 3T. Via the screen 3Y of the computer 3, the item of medical information NA which relates to the patient 13A, the item of medical information NB which relates to the patient 13B and the item of medical information NC which relates to the patient 13C can be displayed simultaneously. The data transfer unit TS-M is formed by the data transfer module WT1 and at least one of the data transfer modules WT2 and 3T. The data transfer unit TS-M can be based, for example, on wireless data transference and/or a radio network and/or on at least one base station to which the data transfer modules WT1, WT2 and 3T can each be connected.

In particular, via the data processing system, an item of medical information can be selected, on the basis, for example, of a deviation of a characteristic variable of the physiological parameter from a reference value. This can be, for example, the item of medical information NC for a patient 13C whose heartbeat frequency exceeds a threshold value. The selected item of medical information can be displayed to the operating person via the second display unit WY2 of the second wearable W2. Furthermore, based upon the items of medical information, a series of the patients for the examination via the medical imaging device 2 can be determined and/or a patient can be selected for the examination via the medical imaging device 2.

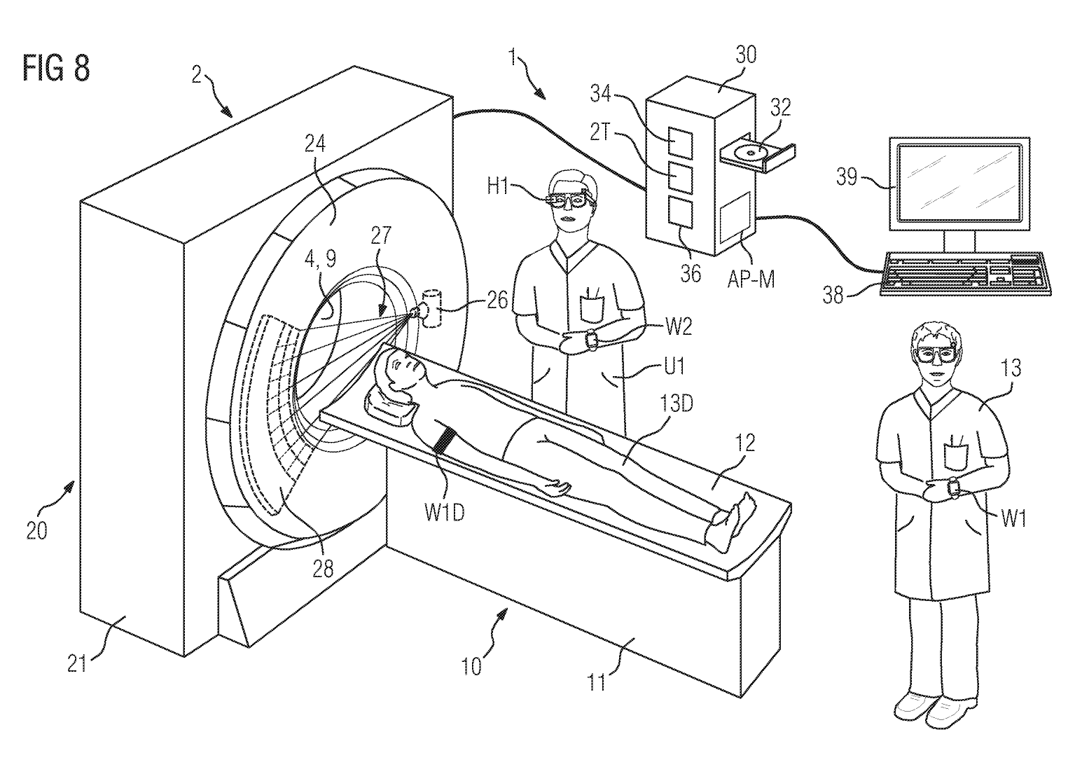

FIG. 8 shows a system 1 with a medical imaging device 2 according to a further embodiment of the invention. Without restricting the general inventive concept, for the medical imaging device 2 by way of example, a computed tomography device is shown. The medical imaging device 2 has a gantry 20, the tunnel-shaped opening 9, the patient positioning device 10 and the control device 30.

The gantry 20 comprises the stationary support frame 21 and the rotor 24. The rotor 24 is arranged on the stationary support frame 21 rotatable about a rotation axis relative to the stationary support frame 21.

A patient can be introduced into the tunnel-shaped opening 9. The acquisition region 4 is situated in the tunnel-shaped opening 9. In the acquisition region 4, a region of a patient that is to be imaged is positionable such that the radiation 27 can pass from the radiation source 26 to the region to be imaged and following an interaction with the region to be imaged, can arrive at the radiation detector 28.

The patient positioning device 10 has the positioning base 11 and the positioning table 12 for positioning a patient. The positioning table 12 is arranged movable relative to the positioning base 11 such that the positioning table 12 is introducible in a longitudinal direction of the positioning table 12 into the acquisition region 4.

The medical imaging device 2 is configured for the acquisition of acquisition data on the basis of an electromagnetic radiation 27. The medical imaging device 2 comprises an acquisition unit. The acquisition unit is a projection data acquisition unit with the radiation source 26, for example, an X-ray source and the detector 28, for example, an X-ray detector, in particular an energy-resolving X-ray detector. The radiation source 26 is arranged on the rotor 24 and is configured for the emission of a radiation 27, for example, an X-ray radiation with radiation quanta 27. The detector 28 is arranged on the rotor 24 and is configured for the detection of the radiation quanta 27. The radiation quanta 27 can pass from the radiation source 26 to the region of a patient that is to be imaged and following an interaction with the region to be imaged, can arrive at the detector 28. In this way, via the acquisition unit, acquisition data of the region to be imaged can be acquired in the form of projection data.

The control device 30 is configured for receiving the acquisition data acquired by the acquisition unit. The control device 30 is configured to control the medical imaging device 2. The control device 30 is a computer and has the computer-readable medium 32 and the processor system 36.

The control device 30 has the imaging reconstruction apparatus 34. Via the imaging reconstruction apparatus 34, on the basis of the acquisition data, a medical image data set can be reconstructed.

The medical imaging device 2 has an input device 38 and an output device 39 which are each connected to the control device 30. The input device 38 is configured for the input of control information, for example, image reconstruction parameters, examination parameters or the like. The output device 39 is configured, in particular, for the output of control information, images and/or sounds.

The control device 30 of the medical imaging device 2 comprises the examination parameter adaptation unit AP-M and the data transfer module 2T. The data transfer unit TD-M is formed by the data transfer module 2T and at least one of the data transfer modules WT1, WT2 and 3T. The data transfer unit TD-M can be based, for example, on wireless data transference and/or a radio network and/or on at least one base station to which the data transfer modules WT1, WT2 and 3T can each be connected.

The item of medical information N which relates to the patient 13 and/or an item of medical information which relates to the patient 13D can be output, for example, via a pair of data glasses H1 in the form of an item of extended reality information in a visual field of the operating person U1. The patient 13D wears the first wearable W1D in the form of a fitness armband on an upper arm.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for outputting an item of medical information concerning at least one of a suitability of a patient for an examination via a medical imaging device and a patient-specific configuration of a medical imaging device, the method comprising:
acquiring, via a first wearable worn by the patient, a measurement data series relating to at least one physiological parameter of the patient;
determining the item of medical information based upon the acquired measurement data series; and
outputting the determined item of medical information.

2. The method of claim 1,
wherein the first wearable includes a first data processing unit,
wherein a first software application is executable by the first data processing unit, and
wherein the medical information is at least one of determinable and outputtable by way of the first software application.

3. The method of claim 1, further comprising:
provisioning an item of reference information concerning at least one of
an identification of at least one of the examination and the medical imaging device and
at least one of examination-specific and a device-specific condition on the at least one physiological parameter of the patient,
wherein the item of medical information is further determined based upon the provisioned item of reference information.

4. The method of claim 1, further comprising:
transferring data between the first wearable and a data processing system, the data comprising at least one element selectable from a group which consists of the measurement data series, the medical information, reference information and combinations of at least two of the measurement data series, the medical information and the reference information,
wherein the data processing system comprises a second data processing unit and wherein a second software application is executable by the second data processing unit, and
wherein the medical information is at least one of determinable and outputtable by way of the second software application.

5. The method of claim 2,
wherein the data processing unit comprises a second wearable, worn by an operating person.

6. The method of claim 1,
wherein the first wearable comprises a first display unit, and
wherein the medical information is displayed via the first display unit.

7. The method of claim 1, further comprising:
transferring data between the first wearable and the medical imaging device,
wherein the data comprises at least one element selected from the group consisting the measurement data series, the medical information, reference information and combinations of at least two of the measurement data series, the medical information and the reference information.

8. The method of claim 1, further comprising:
adapting at least one examination parameter of the medical imaging device based upon the item of medical information.

9. The method of claim 1, wherein at least one of:
the medical information comprises a first item of information indicating whether the patient is suitable for the examination via the medical imaging device, the item of medical information comprising a second item of information indicating at least one of whether and how the suitability of the patient for the examination is at least one of creatable and improvable,
the item of medical information comprises a third item of information relating to at least one of a characteristic variable of the physiological parameter of the patient and a measure for a deviation of a characteristic variable of the physiological parameter of the patient from a reference value, and
the medical information comprises a fourth item of information indicating at least one of whether and how the configuration of the medical imaging device is patient-specifically optimizable for the examination of the patient.

10. The method of claim 1,
wherein the measurement data series relates to a heart activity of the patient.

11. A system, comprising:
a first wearable, including an acquisition unit configured to acquire a measurement data series relating to at least one physiological parameter of the patient;
a determination unit, configured to determine an item of medical information based upon the acquired measurement data series, wherein the item of medical information concerns at least one of a suitability of the patient for an examination via a medical imaging device and a patient-specific configuration of a medical imaging device for an examination of the patient; and
an output unit, configured to output the determined item of medical information.

12. The system of claim 11, further comprising
a data processing system, and
a data transfer unit, configured to transfer data between the first wearable and the data processing system,
wherein the data processing system includes at least one of the determination unit and the output unit.

13. The system of claim 11, wherein the first wearable comprises at least one of the determination unit and the output unit.

14. The system of claim 11, further comprising
the medical imaging device;
a data transfer unit, configured to transfer data between the first wearable and the medical imaging device and/or between the data processing system and the medical imaging device; and
an examination parameter adaptation unit, configured to adapt at least one examination parameter of the medical imaging device based upon the item of medical information.

15. A method, comprising:
acquiring, via a first wearable, a measurement data series relating to at least one physiological parameter of a patient wearing the first wearable;
outputting, via the first wearable, an item of medical information determined based upon the measurement data series, the item of medical information being one which concerns at least one of a suitability of a patient for an examination via a medical imaging device and a patient-specific configuration of a medical imaging device for an examination of a patient.

16. A method, comprising:
acquiring, via a system including a first wearable and a second wearable, a measurement data series relating to at least one physiological parameter of a patient wearing the first wearable;
outputting, via the second wearable, an item of medical information determined based upon the measurement data series, the item of medical information being one which concerns at least one of a suitability of a patient for an examination via a medical imaging device and a patient-specific configuration of a medical imaging device for an examination of a patient.

17. The method of claim 2, further comprising:
provisioning an item of reference information concerning at least one of
an identification of at least one of the examination and the medical imaging device and
at least one of examination-specific and a device-specific condition on the at least one physiological parameter of the patient,
wherein the item of medical information is further determined based upon the provisioned item of reference information.

18. The method of claim 2, further comprising:
transferring data between the first wearable and a data processing system, the data comprising at least one element selectable from a group which consists of the measurement data series, the medical information, reference information and combinations of at least two of the measurement data series, the medical information and the reference information,
wherein the data processing system comprises a second data processing unit and wherein a second software application is executable by the second data processing unit, and
wherein the medical information is at least one of determinable and outputtable by way of the second software application.

19. The method of claim 3, further comprising:
transferring data between the first wearable and a data processing system, the data comprising at least one element selectable from a group which consists of the measurement data series, the medical information, the reference information and combinations of at least two of the measurement data series, the medical information and the reference information,
wherein the data processing system comprises a second data processing unit and wherein a second software application is executable by the second data processing unit, and
wherein the medical information is at least one of determinable and outputtable by way of the second software application.

20. The method of claim 4,
wherein the data processing system comprises a second wearable, worn by an operating person, and wherein the second wearable comprises the second data processing unit.

21. The method of claim 4,
wherein at least one of
the first wearable comprises a first display unit and the data processing system comprises a second display unit, and
wherein the medical information is displayed via at least one of
the first display unit and
the second display unit.

22. The method of claim 4, further comprising:
transferring data between at least one of
the first wearable and the medical imaging device and
the data processing system and the medical imaging device,
wherein the data comprises at least one element selected from the group consisting the measurement data series, the medical information, the reference information and combinations of at least two of the measurement data series, the medical information and the reference information.

23. The method of claim 2,
wherein the measurement data series relates to a heart activity of the patient.

24. The system of claim 12, wherein at least one of
the first wearable comprises at least one of the determination unit and the output unit; and
the data processing system comprises a second wearable which comprises at least one of the determination unit and the output unit.

25. The system of claim 12, further comprising
the medical imaging device;
a data transfer unit, configured to transfer data between at least one of
the first wearable and the medical imaging device and
the data processing system and the medical imaging device; and
an examination parameter adaptation unit, configured to adapt at least one examination parameter of the medical imaging device based upon the item of medical information.

26. The system of claim 24, further comprising
the medical imaging device;
a data transfer unit, configured to transfer data between at least one of
the first wearable and the medical imaging device and
the data processing system and the medical imaging device; and
an examination parameter adaptation unit, configured to adapt at least one examination parameter of the medical imaging device based upon the item of medical information.
